(19) United States
(12) Patent Application Publication
(10) Pub. No.: US 2022/0041077 A1
(43) Pub. Date: Feb. 10, 2022

(54) LOWER HIGH VOLTAGE ELECTRICAL SYSTEM FOR TANDEM REAR AXLE ELECTRIC VEHICLE

(71) Applicant: Orange EV, LLC, Riverside, MO (US)

(72) Inventor: Kurt J. Neutgens, Parkville, MO (US)

(21) Appl. No.: 16/991,097

(22) Filed: Aug. 12, 2020

Related U.S. Application Data
(60) Provisional application No. 63/061,130, filed on Aug. 4, 2020.

(51) Int. Cl. B60L 58/12; B60L 3/00; B60L 58/20

(52) U.S. Cl. CPC B60L 58/12; B60L 3/0046; B60L 2240/547; B60L 2200/36; B60L 2240/427; B60L 58/20

(57) ABSTRACT

An electrical system is described herein, where the electrical system may be implemented as a low voltage electrical system for a tandem rear axle of an electric vehicle. In an embodiment, the electrical system may include a battery pack including a plurality of battery blocks, each battery block of the plurality of battery blocks including one or more batteries, where the one or more batteries of each of the plurality of battery blocks are arranged in series, and where the battery blocks of the plurality of battery blocks of the battery pack are arranged in parallel. The electrical system may also include a motor coupled via electric components with the battery pack to receive power from the battery pack within a target voltage range and the axle may be coupled with the motor, where the axle is driven by the motor.

### CROSS REFERENCE TO RELATED APPLICATIONS

This application claims priority to U.S. Provisional Application No. 63/061,130 filed on Aug. 4, 2020, the contents of which is hereby incorporated by reference in its entirety.

### TECHNICAL FIELD

The following relates generally to an electric vehicle, and more specifically to a safer high voltage electrical system to be implemented in a tandem rear axle vehicle.

### BACKGROUND

Electric vehicles are increasingly used for transportation as consumer vehicles and as commercial delivery vehicles. Electric commercial delivery vehicles may include electric tractors, which are often used for moving tractor trailers in various applications. In some cases, tractor trailers may be fully electric, that is, powered entirely by an electric motor. Some electric vehicles, such as electric commercial delivery vehicles and other heavy duty electric vehicles, may use a tandem rear axle to handle heavy loads, for example, to reduce wear, to distribute the weight of heavy loads, or to meet road loading requirements. Some such electric vehicles may use a very high voltage (e.g., more than 300 volts direct current (VDC)) for powertrains used with tandem rear axle vehicles, but this very high voltage may be dangerous for an operator. Accordingly, a relatively lower high voltage electrical system for powertrains with tandem rear axles of electrical vehicles may be desirable so that an operator may not be required to wear personal protective equipment (PPE) and/or may be safer during operation wearing about the same level of PPE.

### SUMMARY

An electrical system is described herein, where the electrical system may be implemented as a lower high voltage electrical system for a powertrain for a tandem rear axle of an electric vehicle. In an embodiment, the electrical system may include a battery pack including a plurality of battery blocks, each battery block of the plurality of battery blocks including one or more batteries, where the one or more batteries of each of the plurality of battery blocks are arranged in series, and where the battery blocks of the plurality of battery blocks of the battery pack are arranged in parallel. The electrical system may also include a motor coupled via electric components with the battery pack to receive power from the battery pack within a target voltage range and the axle may be coupled with the motor, where the axle is driven by the motor, or, additionally or alternatively, where one or more motors may be within one or more of the tandem axles.

In some examples, a number of the one or more batteries of each of the battery blocks is based on the target voltage output of the battery pack. In some examples, the target voltage output is determined so as not to exceed a voltage threshold. In some examples, the voltage threshold is based on a safety risk to an operator or repair mechanic of the electric vehicle. In some examples, a number of the one or more batteries of each of the battery blocks is based on the target amperage of the electrical system.

In some examples, the electrical system may further include a motor controller coupled with the battery pack and the motor, where the motor controller controls an output power for the motor. In some examples, the motor controller receives a throttle input from an operator of the electric vehicle, where the output power for the motor is based on the throttle input. Additionally or alternatively, the motor controller receives a throttle input from an autonomous controller and thus is independent from an operator of the electric vehicle, where the output power for the motor is based on the autonomous controller input. In some examples, the motor includes a lower high voltage wound motor configured to operate at the target voltage range, the target voltage range not exceeding a voltage threshold.

In some examples, the electrical system may further include a plurality of battery packs coupled with a plurality of motors, where each battery pack of the plurality of battery packs is coupled with a respective one of the plurality of motors, and where each of the plurality of motors is coupled with one or more components to drive the axle.

In some examples, the electrical system may further include high amp contactor switchably coupled with the battery pack, the high amp contactor being operable to connect and to disconnect the switchable coupling with the battery pack. In some examples, the high amp contactor may be operable based on input received from the operator, such as a traditional key, a keyless start, or other input device. In some examples, the high amp contactor may be operated based on inputs from an autonomous controller.

In some examples, the electrical system may further include a battery management system, where the battery management system is coupled with the battery pack and balances a capacity between each battery block of the plurality of battery blocks. In some examples, the battery management system balances the capacity between each battery block based on a voltage, temperature, amperage, a state of charge, or a combination thereof, for each battery block. In some examples, the battery management system can monitor and shut down the system to protect the batteries if one or more is out of an expected or predetermined range (e.g., exceeding a predetermined or configured threshold).

In some examples, the electrical system may further include a battery charger, where the battery charger is coupled with the battery pack and is operable to recharge each battery block of the plurality of battery blocks. In some examples, the battery charger recharges each of the battery blocks based on a respective capacity of each of the battery blocks.

In some examples, the vehicle system may further include a transmission coupled with the motor and/or the axle directly or through a driveshaft, or as part of the electric axle, where the transmission may regulate a power and/or a torque to the axle.

In some examples, the vehicle system may further include a gear reducer coupled with the motor and/or the axle directly or through a driveshaft, or as part of the electric axle, where the gear reducer may regulate a power and/or a torque to the axle.

In some examples, the axle is a tandem axle. In some examples, the target voltage range is less than or equal to 125 volts. In some examples, the target voltage range is less than or equal to 145 volts. In some examples, the target voltage range is less than or equal to 250 volts. In some examples, the electric vehicle is an electric tractor, the electric tractor being coupleable to a tractor trailer and or an electric tractor trailer.

### BRIEF DESCRIPTION OF THE FIGURES

FIG. 1 shows an electric vehicle that uses a tandem rear axle in accordance with aspects of the present disclosure.

FIG. 2 shows a battery for use with an electrical system for use with a tandem rear axle electric vehicle in accordance with aspects of the present disclosure.

FIG. 3 is a schematic representation of an electrical system for use with a tandem rear axle electric vehicle in accordance with aspects of the present disclosure.

FIG. 4 is a schematic representation of a battery block for use with a tandem rear axle electric vehicle in accordance with aspects of the present disclosure.

### DETAILED DESCRIPTION OF THE EMBODIMENTS

Some current electric vehicles, such as heavy duty electric vehicles using a tandem rear axle, may use a dangerously high, high voltage system (e.g., a high voltage system with a voltage from 251 VDC to 1800 VDC), along with one or more very low voltages (0-48V) to control, power, and operate the tandem rear axle, which causes potentially unsafe conditions for operators and maintenance personnel of the respective electrical vehicles. According to the techniques described herein, a combination of electrical components, such as batteries (e.g., contained in boxes of an electric vehicle or electric tractor, the number of which can be increased or decreased based on usage requirements), cables, motor (or plurality of motors), motor controller (or plurality of motor controllers), contactors which are designed specifically for a lower high voltage system, and other like electrical components may form an electrical system that has a lower high voltage and thus safer for use by the operators and maintenance personnel. The lower high voltage system described herein may still provide, for example, sufficient power to the vehicle to haul loads of up 190,000 pounds gross combined vehicle weight (GCVW) at highway speeds while utilizing a safer high voltage. In addition, a lower high voltage battery management system may use a very low voltage system (0-48V) along with the lower high voltage system to monitor and control the voltage and temperature of the batteries in the lower high voltage electrical system and monitor and or assist in control of the overall amperage. The lower high voltage battery management system may also track a state of a charge of the batteries and may balance the capacity of each battery block to ensure prolonged battery life.

Some current electrical systems for electrical vehicle tandem rear axle electric vehicles may be based on an electric passenger vehicle design, rather than being designed for a heavy duty or commercial electric vehicle. For example, these systems may operate at a direct current (DC) voltage level of over 300 volts DC (VDC). Further, electric passenger vehicle technology has been driven by the need to increase range at a price comparable to gasoline vehicles, and the use of higher voltages may reduce the size of power cables, contactors, motors, etc. As such, for a mass-produced vehicle where it is possible to get volume pricing on a custom design, the weight, package space, and cost to create an electric vehicle may be reduced by using a relatively higher voltage because for the same power, lower amperage components may be customized for a particular vehicle. This weight loss has been achieved by utilizing less safe and higher high voltage systems coupled with a transmission to generate the necessary speed. Therefore, the use of the low voltage electrical systems for electrical vehicle tandem rear axle electric vehicles as described herein (e.g., operating at a level below 250 VDC) may eliminate a substantial amount or a majority of the safety risks associated with the use of these electric vehicles.

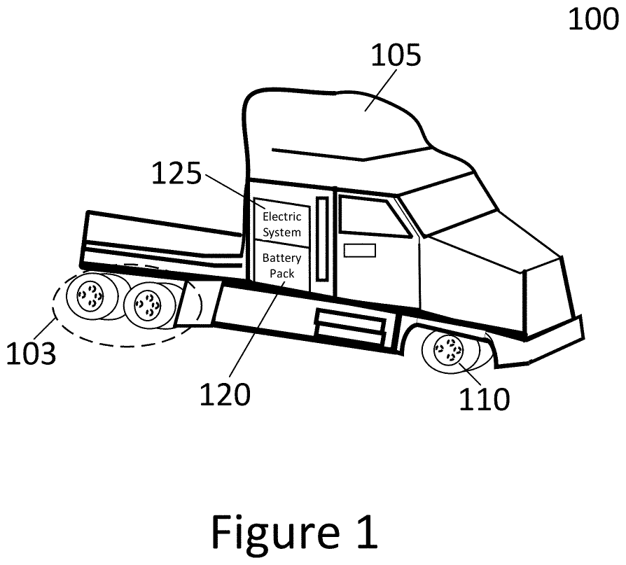

FIG. 1 shows an electric vehicle 100 that uses a tandem rear axle 103 in accordance with aspects of the present disclosure. The electric vehicle 100 may be a tractor 105 for example, as illustratively shown in the example of FIG. 1, but may alternatively be any other vehicle. The tractor 105 may be attached to a trailer, in some examples, to haul a relatively large load.

The electric vehicle 100 may be constructed on a chassis, where each of the components described herein may be coupled with the chassis. The chassis may also be coupled with a drive train which may transfer energy to a number of wheels on one or more axles 103 and 110 to provide locomotion for the electric vehicle 100.

In some cases, the electric vehicle 105 may be fully electric, and thus traction drive and/or braking systems may also be fully electric. The electric vehicle 105 has one or more electric motor(s) that are the main source of propulsion. The electric vehicle may include a front axle 110 and a rear axle 103, where the rear axle may be a tandem axle. In some examples, the front axle 110 may also be a tandem axle. Some electric vehicles, such as electric commercial delivery vehicles and other heavy duty electric vehicles, may use a tandem rear axle to handle heavy loads, for example, to reduce wear and to distribute the weight of heavy loads. Each of the axles 103 on the electric vehicle 100 may be one or multiple axles 103. In some cases, the electric vehicle 105 may have one or more motors within each of the axles 103 and 110.

The electric vehicle 100 holds batteries in a battery pack 120, which may supply the energy to the motor of the electric vehicle 100 and may supply enough energy for an eight-hour drive or more at highway speeds. Energy from the battery pack 120 can be transmitted to other components of the electric vehicle 100 via an inductive or conductive bidirectional coupler or other circuitry components, for example, via an electric system 125, as is further described herein.

In some cases, forward propulsion of the electric vehicle 100 may be controlled by an accelerator pedal, which may have a position that is read by a vehicle controller (e.g., included in or using a component of the electric system 125) that commands a power, torque, and/or speed of the motor. In this case, a position of a pedal depression signifies a speed that the operator intends for the electric vehicle 100. In some cases, the intended power and/or torque and or speed can be commanded by an autonomous vehicle controller. Accordingly, depressing the accelerator pedal or providing a command from the autonomous controller may cause the electric vehicle 100 to accelerate until it reaches a speed corresponding to the position of the pedal depression of the accelerator pedal or the command from the autonomous controller. When the pedal is released to a position that represents a lower speed, or the autonomous controller provides a command for a lower power and or torque and or speed, the traction motor turns into a generator using the motor controller to implement a regenerative breaking mode. Accordingly, forward motion may be retarded and energy may be converted to electricity to be stored in the battery pack 120. In the event of an emergency stop, the operator will take their foot off the accelerator pedal and depress the break. In the time it took to retract the accelerator pedal and start to depress the break the electric vehicle 100 will have already slowed the vehicle and stored some energy in the battery pack 120. In some cases, the electric vehicle 100 may have a traction motor also and regenerative breaking may be accomplished by the traction drive.

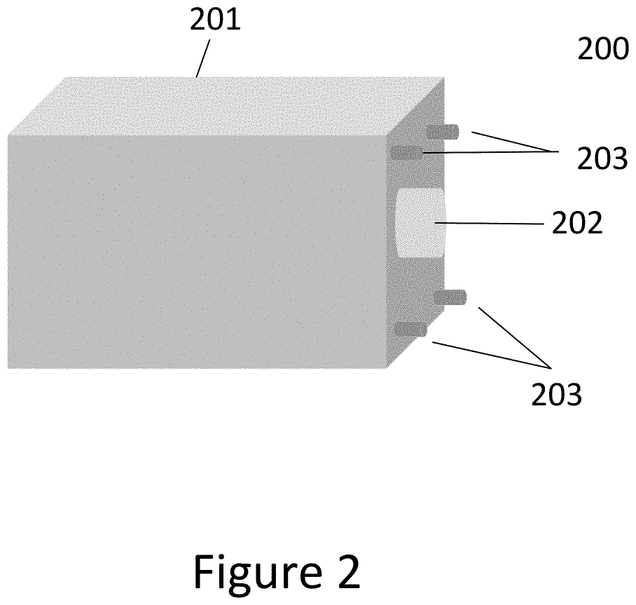

FIG. 2 shows a battery 200 for use with an electrical system for a tandem rear axle electric vehicle in accordance with aspects of the present disclosure.

The battery 200 may be a packaged battery sub system, which may include the battery 200 packaged into a container 201 with electronics that allow it to interface with the electrical system including power and control, and communication. The battery module 200 may include an inductive or conductive power connection 202 that mates with an inductive or conductive receiver, for example, to provide bidirectional power flow. The battery module 200 may be interchangeably coupleable (e.g., hot swappable) such that a battery maybe be removed and a new battery inserted without deenergizing the system. The battery 200 may slide in its receptacle and has jacking screws 203 so it may be mechanically attached to the electric vehicle and remain in place during the shock and vibration of transportation. The battery 200 may also include a bidirectional communication system for monitoring and control. As the electric vehicle may include numerous batteries 200, each of the batteries 200 may be identical except for the amount of energy they store, power rating and physical size, or, alternatively, may vary in one or more of these or other parameters.

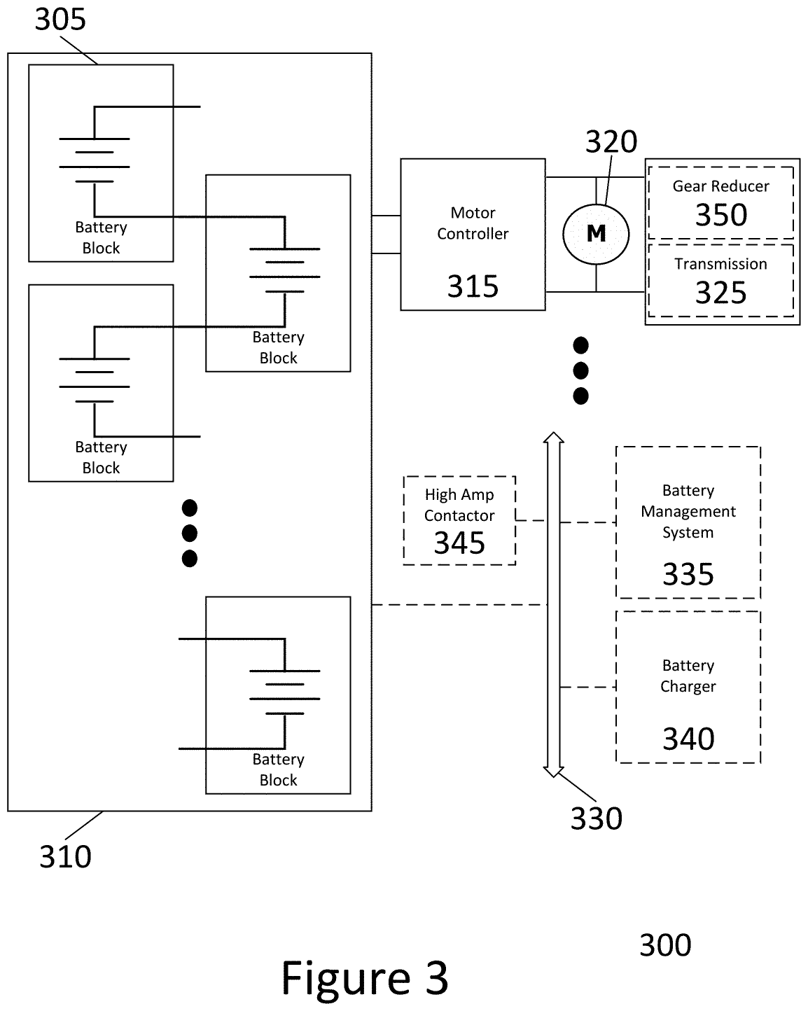

FIG. 3 is a schematic representation of an electrical system 300 for a tandem rear axle electric vehicle in accordance with aspects of the present disclosure. In some examples, the axle is a tandem axle. In some examples, the target voltage range is less than or equal to 125 volts. In some examples, the target voltage range is less than or equal to 145 volts. In some examples, the target voltage range is less than or equal to 250 volts. In some examples, the electric vehicle is a tractor, the tractor being coupleable to a tractor trailer.

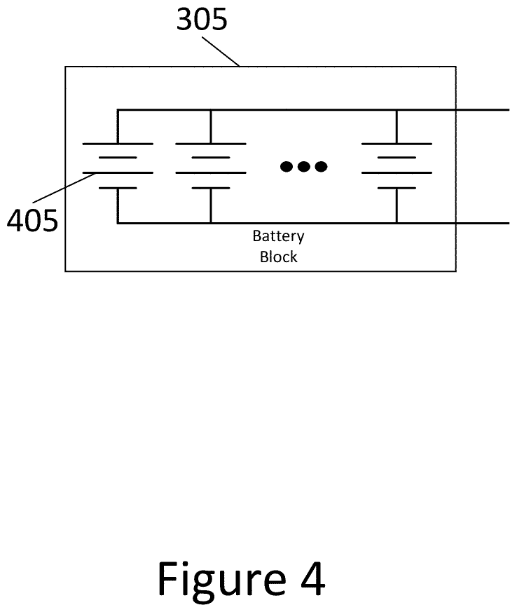

The electrical system 300 may include a battery pack 310 including a plurality of battery blocks 305, where each battery block 305 of the plurality of battery blocks 305 includes one or more batteries (e.g., as described with reference to the battery 200 of FIG. 2). A break-out of one battery block 305 is shown in FIG. 4. In some examples, the batteries within each of the battery blocks 305 may be arranged in parallel, and each of the battery blocks 305 of the battery pack 310 are arranged in series, as is shown in FIG. 3.

FIG. 4 is a schematic representation of a battery block 305 for a tandem rear axle electric vehicle in accordance with aspects of the present disclosure. As shown in FIG. 4, the battery block 305 may include a number of batteries 405 (e.g., from one battery 405 to any other number) configured in parallel. In this way, the count of the number of batteries 405 can be increased (or decreased) without increasing (or decreasing) the voltage in the overall electrical system 300. In some examples, each battery block 305 of the battery block 310 may include a same number of batteries 405. In other examples, one or more of the battery blocks 305 of the battery block 310 may include differing numbers of batteries 405.

In some examples, a number of the one or more batteries of each of the battery blocks 305 is based on the target voltage output of the battery pack 310. In some examples, the target voltage output is determined so as not to exceed a voltage threshold. In some examples, the voltage threshold is based on a safety risk to an operator of the electric vehicle. In some examples, a number of the one or more batteries of each of the battery blocks 305 is based on the target amperage of the electrical system 300.

That is, the batteries may be configured in battery blocks 305, for example, four batteries to a battery block 305. This number of batteries may be adjusted upward depending on desired operation time, for example. Multiple battery blocks 305 (e.g., 34, but, again, this can be adjusted based on a target voltage and/or amperage) may then be interconnected utilizing cables, wiring, busbars, or other circuitry components. A voltage of these interconnected battery blocks 305 may be limited to less than or to not exceed a threshold, for example, to be less than 125 VDC, so that operations are in a safe voltage range. In some cases, this range can be increased and still be below 250 VDC (e.g., including a relatively smaller, or in other cases larger, redundancy factor for safety).

As shown in the illustrative example of FIG. 3, battery packs 310 may be made up of a number of battery blocks 305 in series. Each battery block 305 may be made up of a number of batteries 405 in parallel (e.g., four batteries 405, or any other number of batteries 405). Through the combined use of series and parallel configurations of the batteries 405, the electrical system 300 may maintain a relatively lower voltage output while also maintaining a relatively high amp hour capacity. This combination of low voltage and high amp hours may result in an output with a potential for a large amount of torque with a greatly reduced draw on each individual battery. This may ultimately result in high hauling capacity and extended run time

In some examples, the electrical system 300 may further include a motor 320 motor controller 315 coupled with the battery pack 310 and the motor 320, where the motor 320 motor controller controls an output power for the motor 320. The battery pack 310 may be connected (e.g., via wiring or other circuitry components) to a lower high voltage motor controller 315, which may be connected to and control a lower high voltage wound motor 320. The electrical system 300 may also include a motor 320 coupled via one or more electric components with the battery pack 310 to receive power from the battery pack 310 within a target voltage range and the axle may be coupled with the motor 320, or one or more motors may be part of the axle, where the axle is driven by the motor 320.

In some examples, the electrical system 300 may further include a plurality of battery packs 310 coupled with a plurality of motor 320s, where each battery pack 310 of the plurality of battery packs 310 is coupled with a respective one of the plurality of motor 320s, and where each of the plurality of motors 320 may be coupled with one or more components to drive the axle. That is, the configuration can be expanded with multiple battery packs 310 being connected to multiple motor controllers 315 which may control associated multiple low voltage wound motors 320.

In some examples, the electrical system 300 may further include a plurality of battery packs 310 coupled together to jointly connect with a plurality of motor 320s, where each of the plurality of motors 320 may be coupled with one or more components to drive one or more of the axles. That is, the configuration can be expanded with multiple battery packs 310 being connected to multiple motor controllers 315 which may control associated multiple lower high voltage wound motors 320.

In some examples, the electrical system 300 may further include a transmission 325 coupled with the motor 320 and one or more axles, the transmission 325 regulating a power, torque, and/or speed to one or more axles. For example, the transmission 325 can be added as a component after the lower high voltage wound motor. In some examples, the motor 320 controller receives a throttle input from an operator of the electric vehicle or an autonomous controller, and where the output power for the motor 320 is based on the throttle input or the autonomous controller command. In some examples, the motor 320 includes a lower high voltage wound motor 320 configured to operate at the target voltage range, the target voltage range not exceeding a voltage threshold.

In some examples, the electrical system 300 may further include a gear reducer 350 coupled with the motor 320 and one or more axles, the gear reducer 350 regulating a power, torque, and/or speed to one or more axles. For example, the gear reducer 350 can be added as a component after the lower high voltage wound motor. In some examples, the motor 320 motor controller 315 receives a throttle input from an operator of the electric vehicle or an autonomous controller, and where the output power for the motor 320 is based on the throttle input or the autonomous controller command. In some examples, the motor 320 includes a lower high voltage wound motor 320 configured to operate at the target voltage range, the target voltage range not exceeding a voltage threshold.

In some examples, the electrical system 300 may further include a battery management system 335, where the battery management system 335 is coupled with the battery pack 310 and balances a capacity between each battery block 305 of the plurality of battery blocks 305. In some examples, the battery management system 335 balances the capacity between each battery block 305 based on a voltage, temperature, amperage, a state of charge, or a combination thereof, for each battery block 305.

In some examples, the electrical system 300 may further include a battery charger 340, where the battery charger 340 may be coupled with the battery pack 310 and is operable to recharge each battery block 305 of the plurality of battery blocks 305. In some examples, the battery charger 340 recharges each of the battery blocks 305 based on a respective capacity of each of the battery blocks 305.

In some examples, the electrical system 300 may further include a battery charger 340, where the battery charger 340 can be on-board the electric vehicle or can be off-board the electric vehicle and the battery charger 340 may be coupled with the battery pack 310 and is operable to recharge each battery block 305 of the plurality of battery blocks 305. In some examples, the battery charger 340 recharges each of the battery blocks 305 based on a respective capacity of each of the battery blocks 305.

In some examples, the electrical system 300 may further include one or more high amp contactors 345 switchably coupled with the battery pack 310, the high amp contactor 345 being operable to connect and to disconnect the switchable coupling with the battery pack 310. In some examples, the high amp contactor 345 may be operable based on inputs from the operator including a traditional key, a keyless start, or other input device. In some examples the high amp contactor may be operated based on inputs from an autonomous controller.

This configuration provides the means for locomotion for the electric vehicle. In addition, other lower high voltage motors/components can be attached to this powering system (e.g. hydraulic motor, pneumatic motor, dc-dc converter, heaters, etc.).

In some examples, each of the components of the electrical system 300 may be coupled with or through (e.g., through another additional component) a bus 330. The bus 330 may facilitate communications between different components of the electrical system 300, including to other components that are not shown in FIG. 3, such as a processor, a hard drive or other storage, a wireless communications component, and the like.

In all the examples and embodiments detailed in this application these are examples of possibilities and are not limited to these specifically.

What is claimed is:

1. An electrical system for an electric vehicle with a tandem axle, comprising:
a battery pack comprising a plurality of battery blocks, each battery block of the plurality of battery blocks comprising one or more batteries, wherein the one or more batteries of each of the plurality of battery blocks are arranged in series, and wherein the battery blocks of the plurality of battery blocks of the battery pack are arranged in parallel;
a motor controller coupled via electric components with the battery pack to receive power from the battery pack within a target voltage range;
a motor coupled via electric components with the motor controller and with the battery pack to receive power from the battery pack within a target voltage range; and
the axle coupled with a motor, wherein the axle is driven by the motor or the motor is configured as part of the axle to drive the wheels.

2. The electrical system of claim 1, wherein a number of the one or more batteries of each of the battery blocks is based on the target voltage output of the battery pack.

3. The electrical system of claim 2, wherein the target voltage output is determined so as not to exceed a voltage threshold.

4. The electrical system of claim 3, wherein the voltage threshold is based on a safety risk to an operator or maintenance personnel of the electric vehicle.

5. The electrical system of claim 1, wherein a number of the one or more batteries of each of the battery blocks is based on the target amperage of the electrical system.

6. The electrical system of claim 1, further comprising a motor controller coupled with the battery pack and the motor, wherein the motor controller controls an output power for the motor.

7. The electrical system of claim 6, wherein the motor controller receives a throttle input from an operator of the electric vehicle or from an autonomous controller of the electric vehicle, and wherein the output power for the motor is based on the throttle input.

8. The electrical system of claim 1, wherein the motor comprises a lower high voltage wound motor configured to operate at the target voltage range, the target voltage range not exceeding a voltage threshold.

9. The electrical system of claim 1, further comprising a plurality of battery packs coupled with a plurality of motors, wherein each battery pack of the plurality of battery packs is coupled with one or more of the plurality of motors, and wherein each of the plurality of motors is coupled with one or more components to drive the axle.

10. The electrical system of claim 1, further comprising one or more high amp contactors switchably coupled with the battery pack, the high amp contactor being operable to connect and to disconnect the switchable coupling with the battery pack.

11. The electrical system of claim 10, wherein the high amp contactor is operable based on an input received from an operator of the electric vehicle or from a controller of the electric vehicle.

12. The electrical system of claim 1, further comprising a battery management system, wherein the battery management system is coupled with the battery pack and balances a capacity between each battery block of the plurality of battery blocks.

13. The electrical system of claim 12, wherein the battery management system balances the capacity between each battery block based on a voltage, temperature, amperage, a state of charge, or a combination thereof, for each battery block.

14. The electrical system of claim 1, further comprising a battery charger, wherein the battery charger is coupled with the battery pack and is operable to recharge one or more battery blocks of the plurality of battery blocks.

15. The electrical system of claim 14, wherein the battery charger recharges each of the battery blocks based on a respective capacity of each of the battery blocks.

16. The electrical system of claim 1, further comprising a transmission, a gear reducer, or both, coupled with the motor and the axle, the transmission, the gear reducer, or both, regulating one or more of a power, a torque, and a speed to the axle.

17. The electrical system of claim 1, wherein the axle is a rear axle of the electric vehicle.

18. The electrical system of claim 1, wherein the axle is a front axle of the electric vehicle.

19. The electrical system of claim 1, wherein the axle is a tandem axle.

20. The electrical system of claim 1, wherein the target voltage range is less than or equal to 125 volts.

21. The electrical system of claim 1, wherein the target voltage range is less than or equal to 145 volts.

22. The electrical system of claim 1, wherein the target voltage range is less than or equal to 250 volts.

23. The electrical system of claim 1, wherein the electric vehicle is an electric tractor, the electric tractor being coupleable to a tractor trailer or an electric trailer.
